(19) United States
(12) Patent Application Publication
(10) Pub. No.: US 2006/0057288 A1
(43) Pub. Date: Mar. 16, 2006

(54) Method and device for confinement of a liquid

(76) Inventors: Claire Divoux, Grenoble (FR); Laurent Ortiz, Echirolles (FR)

Correspondence Address: Robert E Krebs;Thelen Reid & Priest, PO Box 640640, San Jose, CA, 95164-0640, US

(21) Appl. No.: 10/539,401

(22) PCT Filed: Dec. 16, 2003
(86) PCT No.: PCT/FR03/50180

§ 371 Date: Jun. 17, 2005

(30) Foreign Application Priority Data
Dec. 17, 2002 (FR) 02/15979

(51) Int. Cl. B05D 5/00; B05D 1/18

(52) U.S. Cl. 427/256; 427/430.1

(57) ABSTRACT

According to the invention, in order to confine a liquid in at least one area of a substrate, a treatment is applied to the surface of the substrate, creating, on this surface, at least one area (54), the wettability of which is larger than that of the surroundings of the area, the substrate is immersed in the liquid, and then it is removed from the latter. Further, after applying the treatment to the surface, a cavity (40) intended to contain the liquid and including a single aperture (41) is formed in the area. The invention is particularly applicable to the filling of cavities of an optical micro-actuator.

### TECHNICAL FIELD

The present invention relates to a method and device for confining a liquid.

It is particularly applicable
to air actuators and to optical actuators,
to electrocapillarity or thermocapillarity fluid actuators and, more generally,
to any actuator or sensor which uses a liquid either as a motor or as a transducer, or as an active or ambient medium.

In particular, the invention is applicable to actuators or to sensors which are intended to contain a liquid. It is also applicable to the assaying or conditioning of a liquid, more specifically in the case when limitation of the localization of this liquid is required.

The invention is for example applicable to the manufacturing of a micro-actuator of the kind known from the following document:

[1] WO 02/48777A, published on Jun. 20, 2002, “an optical micro-actuator, an optical component using the micro-actuator, and method for making an optical micro-actuator”, invention of Claire Divoux and Claude Chabrol.

Let us point out right now that in the case of an application to an optical switch of this kind, with the invention, it is possible to reduce the access to the reservoir of the switch, which allows switching and which, among the parts of the switch where light is not guided, is the one where the light flux loss is usually the highest.

### STATE OF THE PRIOR ART

In the field of biology, the use of assay devices including cavities which are intended to contain a liquid, is known.

In order to properly retain this liquid in each cavity, a surface treatment is applied around these cavities and in the latter.

The filling of the cavities is carried out individually, by means of a micro-dispenser. Thus, the filling is not collective and its duration depends on the number of micro-dispensers which are available as well as on the number of cavities to be filled.

It should further be noted that a micro-dispenser is neither suitable for accurately filling small cavities nor for obtaining an accurate level of liquid. Therefore, it is unusable for filling an optical actuator, the operation of which substantially depends on the level of a meniscus.

### DISCUSSION OF THE INVENTION

The object of the present invention is to find a remedy to the above drawbacks.

It solves the problem of automatically and collectively filling cavities formed on a substrate with a liquid and more generally the problem of automatic and collective confinement of a liquid in areas formed on a substrate.

The invention further is directed to:
automatically, collectively and homogeneously adjusting the volumes and levels of a liquid in cavities formed on a substrate,
homogenizing the volumes and levels of a liquid among such cavities,
accurately controlling the volume and level of a liquid in these cavities, and
maintaining the level of a liquid in these cavities at a stable position.

In particular, in the case of an optical switching array comprising a large number of optical switches, for example of the kind disclosed by document [1], with the invention, it is possible to fill the small volumes of the reservoirs which the switches include, not only collectively, but also accurately, which is essential.

The invention uses sudden changes in the state of a surface of a substrate, at the contours of areas of this surface, in which the intention is to confine a liquid.

Specifically, the object of the present invention is a method for confining a liquid in at least one area of a substrate, this method being characterized in that:
a treatment is applied to the surface of this substrate, capable of creating on this surface at least one area, the wettability of which, i.e., the capability of being wetted by the liquid, is larger than that of the surroundings of this area on the surface,
the substrate is immersed in the liquid, and
this substrate is removed from the liquid.

According to a preferred embodiment of the method object of the invention, rough features are further created on the area or on the surroundings of this area or on both of them.

A cavity intended to contain the liquid may further be formed in the area before applying the treatment to the surface of the substrate.

According to a first particular embodiment of the method, object of the invention, the cavity is filled by immersing the substrate in the liquid, then by lowering the pressure above the liquid, from atmospheric pressure to a pressure less than the saturation vapor pressure of this liquid, subsequently by re-establishing atmospheric pressure and then by removing the substrate from the liquid.

According to a second particular embodiment of the method, object of the invention, the cavity is filled by placing the substrate in a vacuum chamber, and then applying a vacuum to this chamber, then by injecting the liquid into the chamber, until total immersion of the substrate, subsequently re-establishing atmospheric pressure in the chamber and then removing the substrate from the liquid.

In the invention, the applied surface treatment may be capable of making the area both lipophobic and hydrophobic.

In this case, the surface treatment may comprise the deposition of a polytetrafluoroethylene layer on this area.

The liquid may comprise oil and a treatment capable of making the latter lipophilic may then be applied to the area.

Conversely, the liquid may comprise water and a treatment capable of making the latter hydrophilic may then be applied to the area.

The present invention also concerns a device for confining a liquid in at least one area of a substrate, this device being characterized in that the capability of the area to be wetted by the liquid is larger than that of the surroundings of this area on the surface and in that rough features are formed on the area or on the surroundings of this area or on both of them.

According to a particular embodiment of the device, object of the invention, the area includes a cavity intended to contain the liquid.

The area may be both lipophobic and hydrophobic.

To do this, a polytetrafluoroethylene layer may be formed on this area.

### SHORT DESCRIPTION OF THE DRAWINGS

The present invention will be better understood upon reading the description of exemplary embodiments given hereafter, in a purely indicative and absolutely non-limiting way, with reference to the appended drawings, wherein:

FIGS. 1A-1F schematically illustrate steps of a first particular embodiment of the method, object of the invention,

FIGS. 2A-2F schematically illustrate steps of a second particular embodiment of the method, object of the invention,

FIGS. 3A-3E schematically illustrate a first example of filling a device including cavities, according to the invention,

FIGS. 4A-4D schematically illustrate a second example of filling a device including cavities, according to the invention, and

FIG. 5 schematically illustrates the adjustment of the liquid's level in these cavities, according to the invention.

### DETAILED DISCUSSION OF PARTICULAR EMBODIMENTS

A first example of the method, object of the invention, is now described.

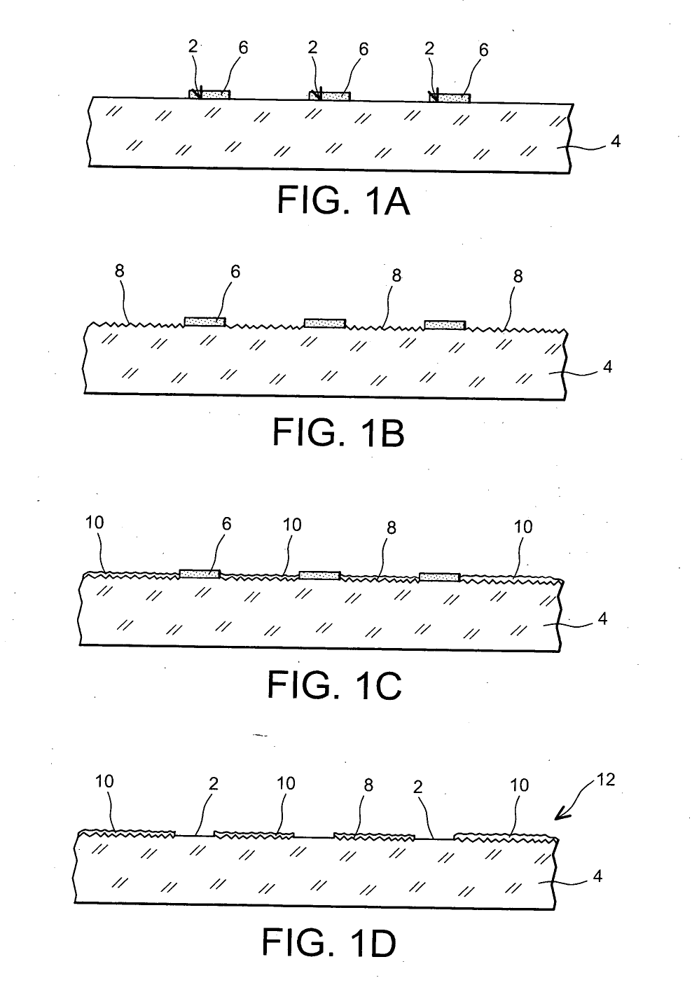

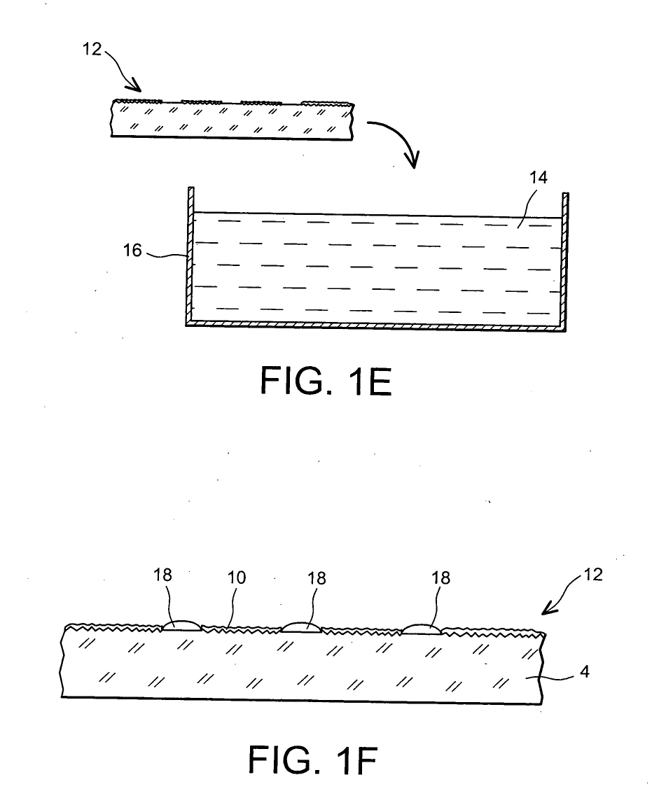

In this first example, the intention is to confine an oil, for example an optical oil (an oil with a determined optical index), in areas 2 of a hydrophobic substrate 4, for example in silicon (FIG. 1A).

To do this, a photoresist layer 6 is formed on each of these areas. Next, on the surroundings of these areas, a lipophobic material layer is formed.

However, beforehand, in order to enhance the lipophobicity of these surroundings, it is preferable to form on the latter, rough features 8 (FIG. 1B), the size of which is of the order of 1 μm for example, and which are called microscopic rough features.

In order to form these microscopic rough features, one proceeds in the following way: the microscopic rough features may be obtained by etching silicon through a non-homogeneous native oxide. Microscopic rough features are thereby formed by the etching selectivity between silicon and silicon oxide.

After having obtained these microscopic rough features 8, the lipophobic material layer 10 is formed on the surroundings of areas 2 (FIG. 1C). This material for example is polytetrafluoroethylene, and one proceeds with deposition for forming the layer 10.

The deposited photoresist is then removed, which exposes the silicon substrate surface at the areas 6 (FIG. 1D).

The thereby obtained substrate 12 is then immersed in the oil 14 or the water contained in a container 0.16 (FIG. 1E). The oil or water thus adheres to the areas. The substrate is then removed from the container.

Oil drops 18 confined in the relevant areas are thereby obtained, the surroundings of these areas not being covered with this oil (FIG. 1F).

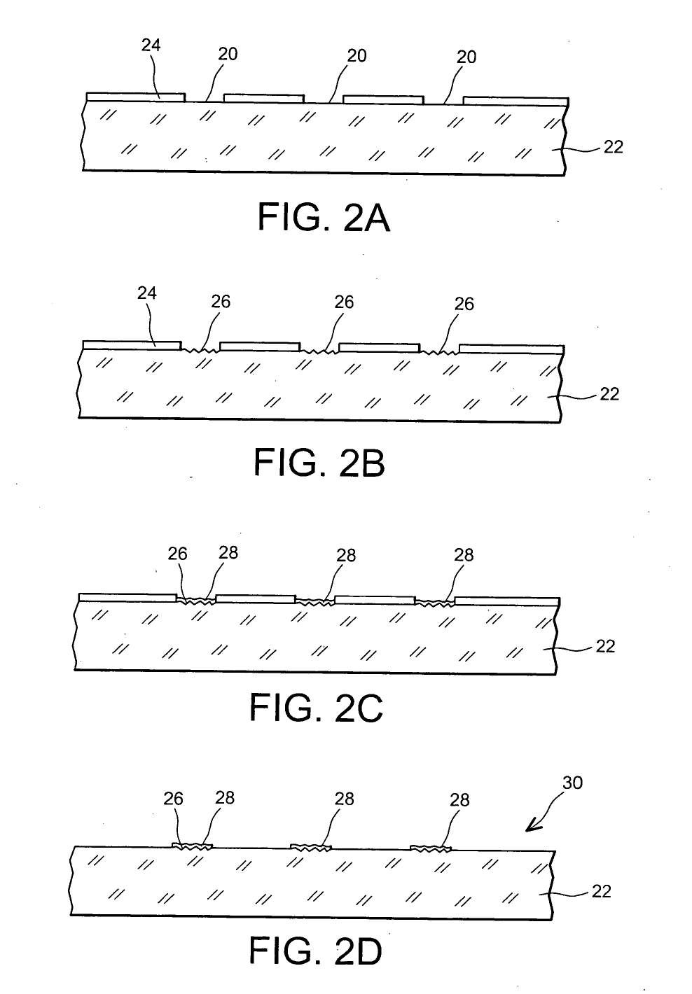

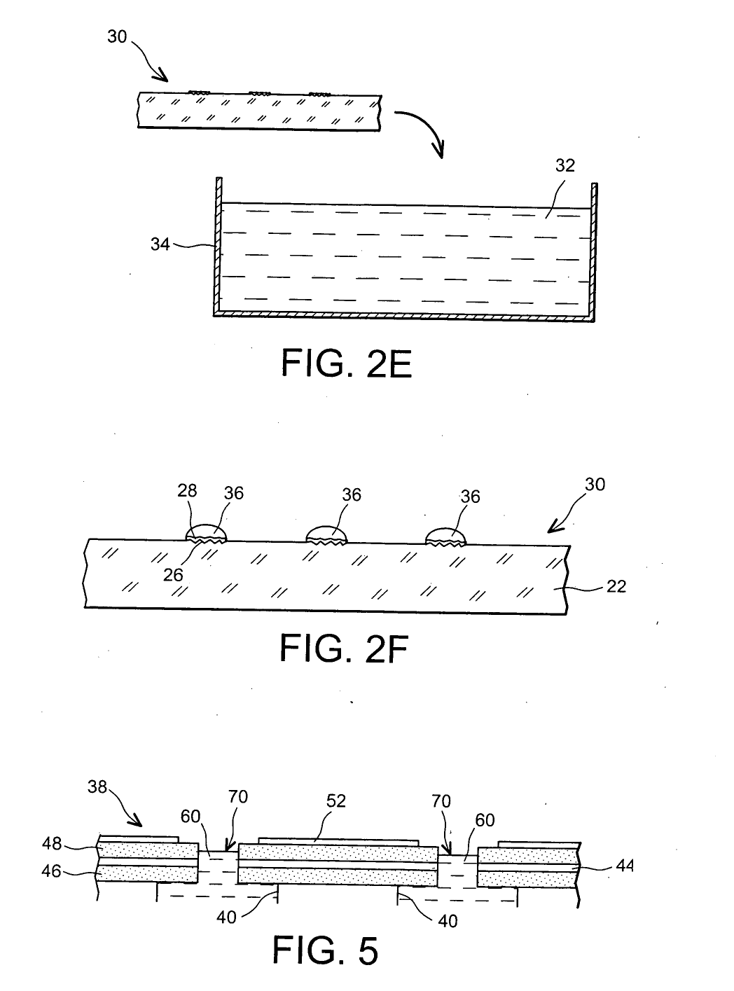

In a second example, it is desired to confine oil in the areas 20 of a hydrophilic, for example silicon substrate 22 (FIG. 2A).

To do this, one starts with forming a photoresist layer 24 on the surroundings of the areas. A treatment of the surface of the substrate is then carried out in order to make the areas lipophilic.

However, in order to enhance the lipophilicity of these areas, it is preferable to form beforehand microscopic rough features 26 on these areas (FIG. 2B).

Next, a layer 28 of lipophilic material, for example polytetrafluoroethylene, is formed on each of the areas 20 (FIG. 2C).

To do this, one proceeds with deposition.

The photoresist is then removed (FIG. 2D).

The thereby obtained substrate 30 is then immersed in the oil 32 contained in a container 34 (FIG. 2E). The oil thereby adheres to the areas having undergone the lipophilic treatment. The substrate is then removed from the container.

Oil drops 36 confined in the relevant areas are thereby obtained, the surroundings of these areas not being covered with oil (FIG. 2F).

In a third example, it is desired to confine water on a silicon substrate.

To do this, one proceeds as explained in the description of FIGS. 2A-2F, by replacing the silica substrate with this silicon substrate, the oil with water and the lipophilic treatment with a hydrophilic treatment, for example based on a metal, such as gold or silver.

This hydrophilic treatment is carried out by a vapor deposition method for example.

In an alternative of the method described with reference to FIGS. 1A-1F, microscopic rough features may initially be formed on the entire surface of the silicon substrate 4, and then the photo-resist coating is formed on each of the areas 2, and then the lipophobic layer 10 is formed on the surroundings of these areas. The photo-resist is then removed then the substrate is immersed in oil and removed from it.

The existence of microscopic rough features on the areas 2 then allows the lipophilicity of these areas to be enhanced.

Also, in the case of the method described with reference to FIGS. 2A-2F, microscopic rough features may initially be formed on the entire surface of the substrate 22, then the photoresist layer 24 followed by the layers 28 may be formed.

The existence of microscopic rough features on the surroundings of areas 20 allows the lipophobicity of these surroundings to be enhanced.

In another example of the invention (not illustrated by the figures), a treatment of the surface of a substrate for example in polytetrafluoroethylene, is carried out to make areas of this substrate both lipophobic and hydrophobic. To do this, a coating of polytetrafluoroethylene may be formed on these areas by the deposition method.

It should be noted that polytetrafluoroethylene has a larger lipophobicity and hydrophobicity than that obtained by any other surface treatment.

Thus, a substrate is made available, provided with areas on which one may choose to deposit a hydrophilic or on the contrary a hydrophobic liquid, whereby this choice may be postponed until the last moment.

A method according to the invention is now described allowing several cavities with which substrate is provided, to be filled with a liquid, each cavity including a single aperture which is used as an inlet for the liquid.

In the illustrated example, this substrate is an optical micro-actuator of the kind of the one described in document [1] mentioned earlier.

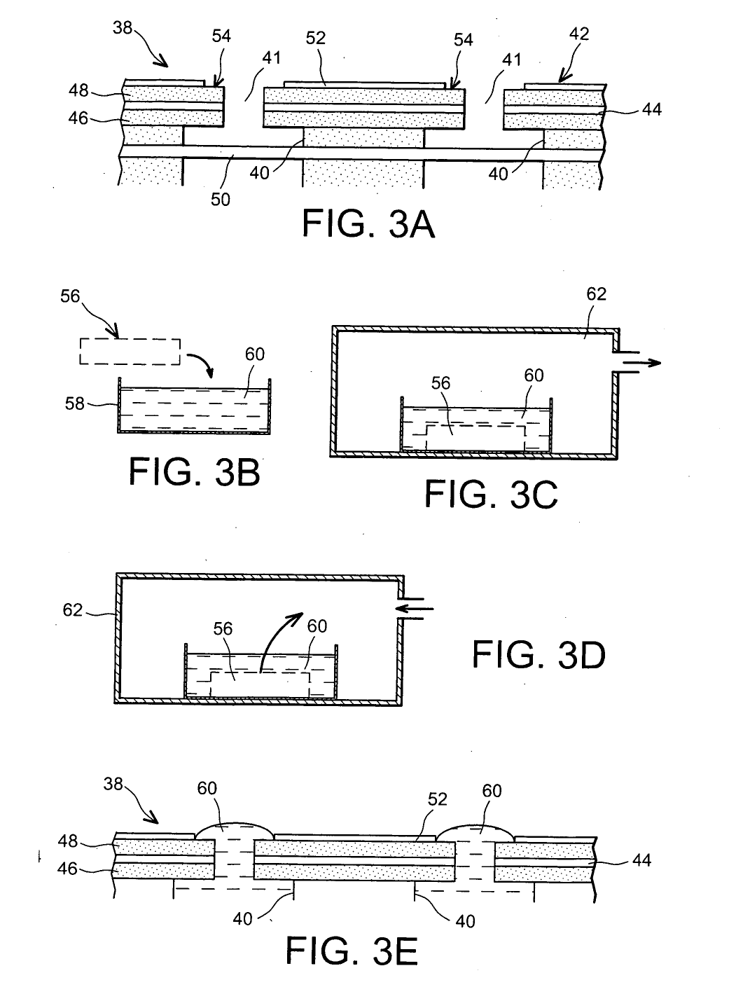

This optical micro-actuator 38 provided with several cavities or reservoirs 40, is schematically and partly illustrated in FIG. 3A. These cavities are formed as explained in document [1]. They are delimited by an optical guide 42, whereof the core 44, the lower confinement layer 46 and the upper confinement layer 48 are seen, and by membranes 50. It is also seen that each cavity 40 includes a single aperture 41 each aperture defining an optical gap.

The liquid used is an optical liquid which may be an optical oil, for example propylene carbonate.

The optical guide 42 is in silica.

One starts with forming at the surface of the upper confinement layer 48, a layer 52 of lipophobic material for example polytetrafluoroethylene, by the deposition technique.

This layer 52 is formed on the surface of the upper confinement layer 48, except at the areas 54 into which the cavities 40 open: in FIG. 3A, it is seen that the layer 52 stops at a certain distance, for example of the order of 10 μm, from each cavity 40.

In order to fill each of the cavities 40 with optical oil, the thereby obtained device 56 is placed in a container 58 containing the optical oil 60 (FIG. 3B).

This container is then placed in a vacuum chamber 62 (FIG. 3C), this chamber 62 is closed, and the pressure in the latter is lowered from atmospheric pressure to a pressure less than the saturation vapor pressure of the oil used. This oil then fills cavities 40.

No air bubble remains trapped in the cavities.

Atmospheric pressure is then re-established in the chamber 62 and the device 56 is removed from the liquid (FIG. 3D).

The micro-actuator 38 is thereby obtained, the cavities 40 of which, including the apertures 41 of the latter, are filled with optical oil, as seen in FIG. 3E.

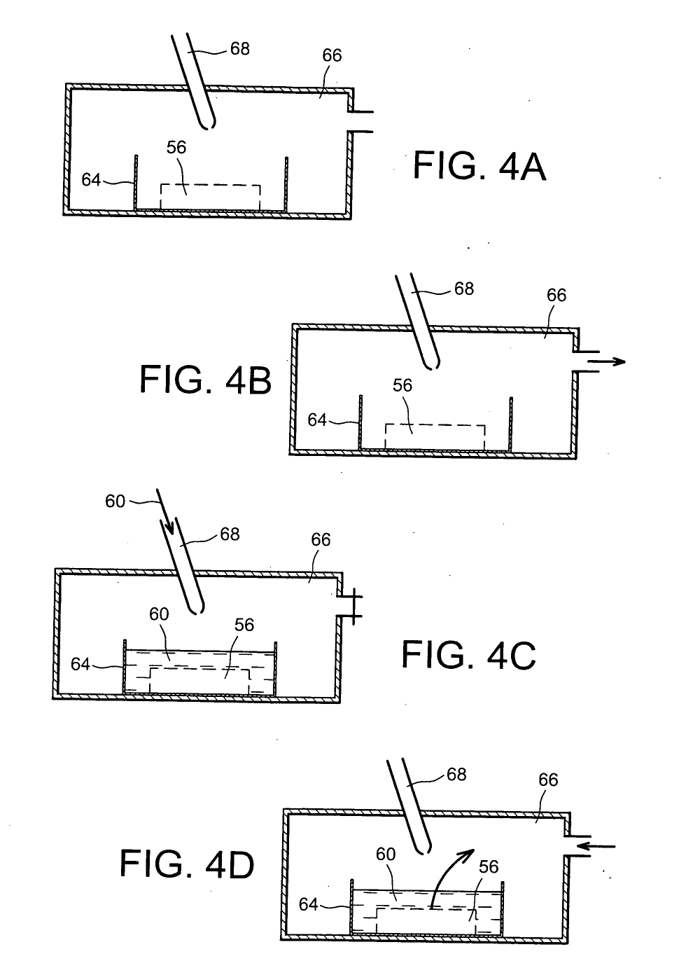

In an alternative, schematically illustrated by FIGS. 4A-4D, the device 56 subject matter of the earlier discussion, is placed in a container 64 (FIG. 4A), this container is placed in a vacuum chamber 66 and vacuum is applied to this chamber 66 (FIG. 4D).

The optical oil 60 is then injected into the container 64, with suitable means 68, for example by a syringe, up to total immersion of the device 56 (FIG. 4C).

The oil then fills the cavities 40.

No air bubble remains trapped in the cavities.

Atmospheric pressure is then re-established in the chamber and the device 56 is removed from the oil (FIG. 4D).

The micro-actuator 38 of FIG. 3E is again obtained, the cavities 40 of which are filled with optical oil 60.

In this case, as in the case of FIG. 3E, the portion of the optical oil which overflows from each cavity may be removed by the simple action of gravity or under the effect of vibrations.

For technical reasons, it is possible that the surface treatment, leading to a sudden change in the state of the surface of the substrate in the plane of the latter, may not be localized at the desired location for the level of the liquid.

In this case, the initially obtained level, if it is not the one which is desired, may be brought back to the desired level, or functional level, for example by evaporation.

This is schematically illustrated by FIG. 5 where it is seen that the initially obtained level for the optical oil 60, in the case of FIG. 3E, has been brought back to the desired level 70 by evaporation.

This evaporation is carried out homogeneously from one cavity to the other.

It is specified that the conventionally used optical liquids are oils, for example propylene carbonate, or liquids which have a small wetting angle, less than 30°, on most surfaces, such as silicon, silica, glass, or parylene surfaces.

As just seen in the earlier examples, with the invention, a liquid, in particular an optical liquid, can be confined in one or several cavities and this liquid can be maintained in the aperture of each cavity. In addition, with the invention, it is possible to control the level of liquid in the cavities and to fill these cavities collectively and accurately.

1. A method for confining a liquid (14, 32, 60) in at least one area (2, 20) of a substrate (4, 22, 56), this method been characterized in that:
a treatment is applied to the surface of this substrate, capable of creating on this surface, at least one area (2, 20), the wettability of which by the liquid is larger than that of the surroundings of this area on the surface,
the substrate is immersed in the liquid (14, 32, 60), and
this substrate is removed from the liquid,
wherein, before applying the treatment to the surface of the substrate, a cavity (40) intended to contain the liquid is further formed in the area, this cavity including a single aperture (41).

2. The method according to claim 1, wherein rough features (8, 26) are further created on the area or on the surroundings of this area or on both of them.

3. The method according to claim 1, wherein the cavity (40) is filled by immersing the substrate (56) in the liquid (60), then by lowering the pressure above the liquid from atmospheric pressure to a pressure less than the saturation vapor pressure of this liquid, subsequently by re-establishing the atmospheric pressure and then by removing the substrate from the liquid.

4. The method according to claim 1, wherein the cavity (40) is filled by placing the substrate (56) in a vacuum chamber (66), then applying vacuum in this chamber, subsequently by injecting the liquid (60) into the chamber, up to total immersion of the substrate, then by re-establishing atmospheric pressure in the chamber and then removing the substrate from the liquid.

5. The method according to claim 1, wherein the applied surface treatment is capable of making the area both lipophobic and hydrophobic.

6. The method according to claim 5, wherein this surface treatment comprises the deposition of a polytetrafluoroethylene layer on this area.

7. The method according to claim 1, wherein the liquid comprises oil (14) and a treatment is applied to the area, capable of making the latter lipophilic.

8. The method according to claim 1, wherein the liquid comprises water and a treatment is applied to the area, capable of making the latter hydrophilic.

9. A device for confining a liquid (14, 32, 60) in at least one area (2, 20) of a substrate (4, 22, 56), this device being characterized in that the wettability of the area by the liquid is larger than that of the surroundings of this area on the surface, and in that rough features (8, 26) are formed on the area or on the surroundings of this area, or on both of them, wherein the area includes a cavity (40) intended to contain the liquid (60), this cavity including a single aperture (41).

10. The device according to claim 9, wherein the area is both lipophobic and hydrophobic.

11. The device according to claim 10, wherein a polytetrafluoroethylene layer is formed on this area.
